(19) United States
(12) Patent Application Publication
(10) Pub. No.: US 2011/0193376 A1
(43) Pub. Date: Aug. 11, 2011

(54) Auxiliary Support for Bicycle Saddle

(75) Inventor: Hyun Hee Cha, Seoul (KR)

(73) Assignee: Beom-Yong Son, Gyeonggi-Do (KR)

(21) Appl. No.: 13/125,296

(22) PCT Filed: Oct. 19, 2009
(86) PCT No.: PCT/KR2009/006026

§ 371 Date: Apr. 20, 2011

(30) Foreign Application Priority Data
Oct. 20, 2008 (KR) 10-2008-0102481

(51) Int. Cl. B62J 1/18

(52) U.S. Cl. 297/214; 297/195.1

(57) ABSTRACT

The present invention relates to an auxiliary support for a bicycle saddle wherein concave and convex parts of the auxiliary support provide support to the left and right and rear parts of a hip area to erect the pelvic bones so that the spinal column is made straight, and a vertical resistive force is generated to withstand the load on the hip joint, and to an auxiliary support for a bicycle saddle, wherein a light frame comprises a flat plate part that consists of a convex part and a curved part of a plane that is formed with a curved part of a curve form connecting both ends of said convex part; and a projection/protrusion part that is formed with said flat plate part into one body so that it may project vertically along said convex part, and a pair of said frames are located at both ends of the top rear part of the saddle symmetrically so that they may surround the edges of the hip.

### TECHNICAL FIELD

The present invention relates to a saddle that is designed so that a bicycle rider can be seated by placing his/her hip portions thereon, and more particularly, to an auxiliary support for a bicycle saddle, in which auxiliary supports are symmetrically attached to both ends of the upper rear portion of the saddle in order to support the pelvis and reduce an impact that would otherwise be applied to the hips and the hip joints.

### BACKGROUND ART

In general, a bicycle saddle is configured such that the entire hips and the private parts of a rider come into contact with the saddle and the flesh of the rider comes into direct contact with the saddle when the rider is seated on the saddle. While riding, not only the hipbones and the pelvic bones of the hips but also the private parts feel continuous pressure. Consequently, pain and tiredness attributable to the pressure increase when the rider is on the saddle for a long time. In some cases, the rider may be injured or suffer from arthritis because of friction with the saddle.

As shown in FIG. 1, the saddle is a seat that is configured so that a bicycle rider can be seated by placing his/her hips thereon. The portions of the saddle that are intended to be in contact with the hips are depressed symmetrically.

When the rider is seated on the saddle, his/her hipbones are placed on the depressed recesses of the saddle, so that the saddle does not support the pelvic bones and the hip joints of the hips. Consequently, as shown in the rear view in FIG. 2, the pelvic bones are laid down, and the vertebrae connected to the pelvic bones are curved backwards. As shown in the side elevation view in FIG. 3, the right and left portions of the hips are not supported, and weight applied to the two hip joints becomes greater. Consequently, a rider having weak hip joints may have pain in those parts.

In addition, since the hipbones of the rider are placed on the depressed recesses of the saddle, the saddle fails to serve as a buffer that absorbs impacts that occur to the hipbones and the hip joints when the bicycle passes over an uneven place while riding.

### DISCLOSURE

### Technical Problem

Accordingly, the present invention has been made keeping in mind the above problems occurring in the related art, and is intended to provide an auxiliary support for a bicycle saddle, in which auxiliary supports, each having a convex-concave part, are provided symmetrically on the rear portion of the bicycle saddle in order to support the right and left portions and the rear portion of the hips, thereby positioning the pelvic bones in a more erect position and reducing weight that would otherwise be applied to the hip joints.

In addition, the present invention serves to provide an auxiliary support for a bicycle saddle, in which a planar part cushion of the auxiliary support is laid on the hipbones and the hip joints, which act as the greatest weights on the saddle, in order to reduce an impact when the bicycle passes over an uneven place.

Furthermore, the present invention serves to provide an auxiliary support for a bicycle saddle, in which a sticker type detachable adhesive is applied on the underside of the auxiliary support so that a rider can adjust the position of the auxiliary support according to his/her body size.

### Technical Solution

In an aspect, the present invention provides an auxiliary support for a bicycle saddle having a frame. In the frame, a planar part includes a convex portion having a C-shaped outline and a curved portion connecting both ends of the convex portion to each other, and a convex-concave part is formed integrally with the planar part. The convex-concave part is erected along the convex portion. Two frames are positioned on both ends of the rear portion of the upper surface of the saddle such that the frames surround the peripheries of hips.

It is preferred that a cushion be laid on the upper front surface of the planar part.

In addition, it is preferred that the auxiliary support further include a cover covering the entire surfaces of the frame and the cushion.

Furthermore, it is preferred that the cover be made of rubber that is highly frictional such that the hips do not slip thereon.

In addition, it is preferred that an adhesive be applied on the outer surface of the cover, which surrounds an underside of the planar part, such that the frame is attachable to and detachable from the surface of the saddle several times.

### Advantageous Effects

Accordingly, the auxiliary support for a bicycle saddle of the invention according to the technical solution as described above is effective in that the convex-concave part of the auxiliary support serves to position the pelvic bones in a more erect position by supporting the left and right portions and the rear portion of the hips. This induces the vertebrae to be straightened and protects the hip joints, so that the rider does not become tired although he/she has ridden for a long time.

In addition, the auxiliary support for a bicycle saddle of the invention reduces an impact that would otherwise be applied to the hipbones and the hip joints by adding the cushion to the planar part. Consequently, people who have weak hip joints can ride on a bicycle without difficulties.

Furthermore, the auxiliary support for a bicycle saddle of the invention can maximize the comfort of the rider by supporting the hips of the rider in the most appropriate position, since the rider can adjust the position of the auxiliary support attached to the saddle according to his/her body size.

### DESCRIPTION OF DRAWINGS

FIG. 1 is a side elevation view showing a typical bicycle with a saddle mounted thereon;

FIGS. 2 and 3 are status views showing the pelvis of a rider who is seated on a bicycle saddle of the related art;

FIG. 4 is a perspective view showing a frame of an auxiliary support for a bicycle saddle of the present invention;

FIG. 5 is a cross-sectional view of FIG. 4;

FIG. 6 is a view showing an application in which the auxiliary support shown in FIG. 4 is attached to a saddle; and

FIGS. 7 and 8 are status views showing the pelvis of a rider who is seated on a bicycle saddle according to an embodiment of the present invention.

### REFERENCE NUMERALS OF THE DRAWINGS

| | |
|---|---|
| 10: frame | 11: convex-concave part |
| 12: planar part | 13: convex portion |
| 14: curved portion | 20: cushion |
| 30: cover | 40: adhesive |

### BEST MODE

Hereinafter, an auxiliary support for a bicycle saddle of the present invention will be described in greater detail with reference to the accompanying drawings, in which embodiments thereof are shown.

FIG. 4 is a perspective view a frame 10 of an auxiliary support 100 for a bicycle saddle of the present invention.

As shown in the figure, the auxiliary support 100 includes a frame 10, a cover 30, and a cushion 20.

The frame 10 is made of a rigid material such as metal (steel), and includes a planar part 12 and a convex-concave part 11.

The planar part 12 is a planar plate that includes a convex portion 13 and a curved portion 14. The convex portion 13 has a “C” shaped outline, and the curved portion 14 has a curved shape so that it connects both ends of the convex portion 13 to each other.

The convex-concave part 11 is a protrusion that is integrally erected along the convex portion 13.

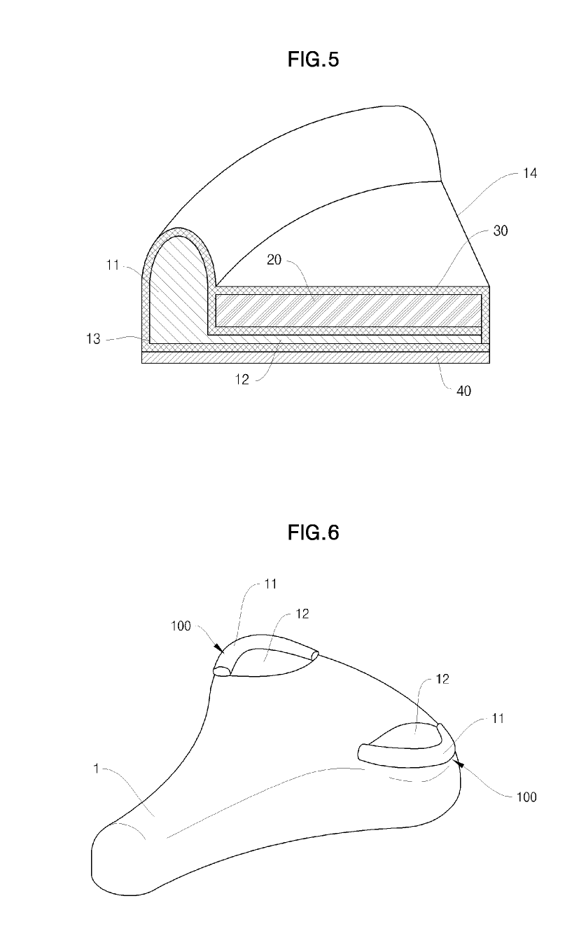

Therefore, as shown in the cross section in FIG. 5, the frame including the convex-concave part and the planar part has an “L” shape configuration.

A cushion 20 made of latex is laid on the upper front surface of the planar part, and a cover 30 that is made of cloth, leather, or rubber covers the entire portion of the frame 10 and the cushion 20.

In addition, the cover 30 also covers the underside of the planar part 12. An adhesive 40 is applied on the lower cover surface, so that the adhesive 40 can be repeatedly attached to and detached from the surface of the saddle.

As shown in FIG. 6, a pair of auxiliary supports 100 having the same configuration is attached to the rear portion of the upper surface of the saddle, one of the auxiliary supports 100 being positioned on one end of the rear portion, and the other auxiliary support 100 being positioned on the other end of the rear portion.

After each convex-concave part 11 of the frames 10 is located on a corresponding one of the edges of the rear portion of the saddle, the interval between the auxiliary supports 100 is increased or decreased according to the size of the rider's hips.

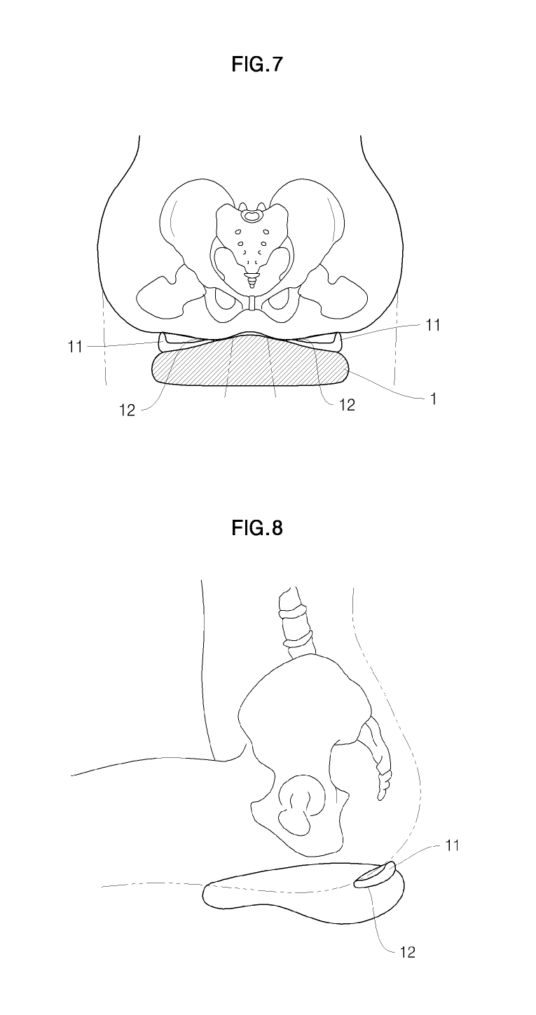

When the rider is seated after the auxiliary support 100 is attached to an appropriate position of the saddle as above, the hips are supported, as shown in FIGS. 7 and 8, thereby minimizing the tiredness of the pelvis and the hip joints.

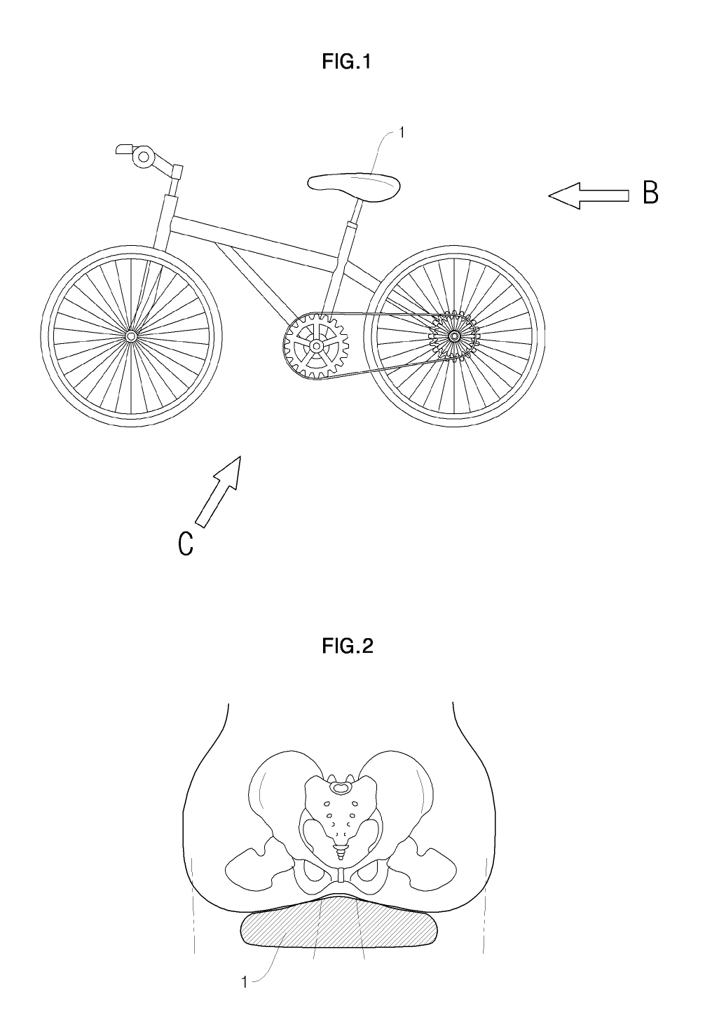

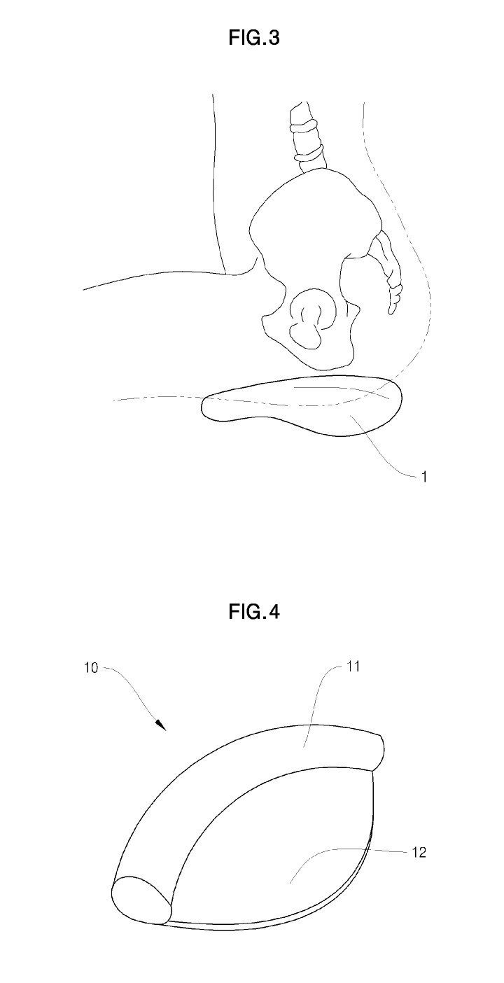

FIG. 7 shows the cross section of the present invention, which is viewed in the direction of B in FIG. 1, as well as the status of the pelvis of the rider.

As shown in the figure, when the rider is seated on the saddle to which the auxiliary support is attached, the rear portion of the hips is pushed up by the convex-concave part 11, so that the pelvic bones are supported so that they stay in the erect position without being laid down. Consequently, the vertebrae are naturally erected.

In addition, since the hip joint portion is in contact with the cushion, weight that is applied from above is supported from below. Even if an impact is applied, the cushion serves to absorb the impact that would otherwise be applied to the hip joints due to the buffering function of the cushion.

FIG. 8 shows the side cross-sectional shape of the present invention, which is viewed in the direction of C in FIG. 1, as well as the status of the pelvis of the rider.

As shown in the figure, both the side portions of the hips are pushed up by the convex-concave part 11 like the rear portion, and the hip joints are supported by the cushion. Consequently, vertical reaction against weight that is applied to the hip joints is produced. The cushion can absorb an external impact when the impact is applied while the bicycle is being ridden.

1. An auxiliary support for a bicycle saddle comprising a frame, wherein the frame comprises:
a planar part including a convex portion having a C-shaped outline and a curved portion connecting both ends of the convex portion to each other; and
a convex-concave part formed integrally with the planar part, wherein the convex-concave part is erected along the convex portion,
wherein a pair of the frames are positioned on both ends of a rear portion of an upper surface of the saddle such that the frames surround peripheries of hips.

2. The auxiliary support according to claim 1, wherein a cushion is laid on an upper front surface of the planar part.

3.-5. (canceled)

6. The auxiliary support according to claim 1, further comprising a cover covering entire surfaces of the frame and the cushion.

7. The auxiliary support according to claim 2, further comprising a cover covering entire surfaces of the frame and the cushion.

8. The auxiliary support according to claim 6, wherein the cover is made of rubber that is highly frictional such that the hips do not slip thereon.

9. The auxiliary support according to claim 7, wherein the cover is made of rubber that is highly frictional such that the hips do not slip thereon.

10. The auxiliary support according to claim 6, wherein an adhesive is applied on an outer surface of the cover, which surrounds an underside of the planar part, such that the frame is attachable to and detachable from a surface of the saddle several times.

11. The auxiliary support according to claim 7, wherein an adhesive is applied on an outer surface of the cover, which surrounds an underside of the planar part, such that the frame is attachable to and detachable from a surface of the saddle several times.
